(19) United States
(12) Patent Application Publication
(10) Pub. No.: US 2017/0337610 A1
(43) Pub. Date: Nov. 23, 2017

(54) Motor Vehicle Data Retrieval, Processing and Presentation Process

(71) Applicant: Monroney Labels, LLC, Hilton Head Island, SC (US)

(72) Inventor: Nicole Michelle Beguesse, Savannah, GA (US)

(73) Assignee: Monroney Labels, LLC, Hilton Head Island, SC (US)

(21) Appl. No.: 15/159,953

(22) Filed: May 20, 2016

(51) Int. Cl. G06Q 30/06; G06F 3/0482; G06F 3/0481; G06F 3/0484; H04L 12/58; G06F 17/30

(52) U.S. Cl. CPC G06Q 30/0623; H04L 51/08; G06Q 30/0641; G06F 17/30876; G06F 3/04817; G06F 3/04842; G06F 3/0482; G06F 17/30569

(57) ABSTRACT

A system and method allowing a user to interact with objects in the user's environment using a hand-held pointing device. The pointing device is preferably incorporated in a hand-held device case or in the hand-held communication device itself. The pointing device projects a light beam that carries an identification code. The user directs the light beam toward an object of interest. The light beam fails upon a detector on the object of interest. The identification code serves to identify the pointing device that has projected the beam. The selected object of interest then sends a transmission providing: (1) its own identity, and (2) the identity of the pointing device. The identity of the selected object and the identity of the pointing device may be used to trigger any number of actions using software running on the selected object itself, a remote server, or a smart phone.

### BACKGROUND OF THE INVENTION

### 1. Field of the Invention

This invention relates to the field of motor vehicles. More specifically, the invention comprises a method and hardware for retrieving information describing a particular motor vehicle and presenting the information in a standardized, understandable format.

### 2. Description of the Related Art

New motor vehicles sold in most major markets around the world have a “window sticker” that lists important feature and pricing information. FIG. 1 shows car 4 with an exemplary window sticker 8 in one of its rear windows 6. The window sticker allows a customer to quickly acquire relevant information.

Window stickers became somewhat standardized in the United States with the passage of the Automobile Information Disclosure Act of 1958. The passage of this act is most closely associated with Senator Mike Monroney of Oklahoma and—for this reason, window stickers are often referred to as “Monroney labels” or “Monroney stickers.” The original legislation required the disclosure of manufacturer's suggested retail pricing for the basic vehicle and for any optional equipment. Amendments over the years have added requirements for fuel economy information and crashworthiness information.

The current requirements in the United States are listed in Title 15 of the United States Code, section 1232. A compliant window sticker must include:

1. The make, model, and vehicle identification number;

2. The final assembly plant;

3. The identity of the dealer to whom the car is delivered, and the location of delivery;

4. The manufacturer's suggested retail price (“MSRP”) for the basic vehicle;

5. THE MSRP for each accessory or item of optional equipment;

6. The amount charged to the dealer for the transportation of the vehicle to the dealer;

7. The total MSRP for the vehicle;

8. Safety ratings released by the U.S. National Highway Traffic Safety Administration.

Additional statutory provisions require the inclusion of warranty and fuel economy information. More recent amendments have added disclosure requirements for hybrid and electric vehicles.

Purchasers of new cars have long relied on window stickers as a reliable starting point for pricing and feature information. While specified information is required to be included in the window sticker—and in some cases a specific type says and area is required—the overall formatting of a window sticker remains discretionary. For this reason, different manufacturers and retailers produce a wide variety of formats.

FIG. 2 graphically depicts one common format. Exemplary Monroney slicker 18 includes: manufacturer information 20, model information 22, summary information 38, standard equipment information 24, warranty information 26, optional equipment information 28, pricing information 29, fuel economy information 30, crash rating information 32, parts content information 34, and vehicle identification number (“VIN”) information 36.

FIG. 3 graphically depicts an exemplary sticker for a Ford Mustang automobile. The “look and feel” of the stickers varies considerably from manufacturer to manufacturer—even though all present the same basic information. In FIG. 3, for example, manufacturer information 20 is presented as a graphical logo. These variations are familiar to new car shoppers.

Until recent times, shopping for a new car commenced with a prospective buyer walking around a dealer's physical lot. This activity has now largely been replaced by web browsing, where a buyer may look through the inventory of many different dealers before ever physically visiting a lot. The window sticker is so widely known and so commonly used, however, that many dealers now post the window stickers for every vehicle as an electronic file that is available on line. Many of these electronic files are generated by the same system that generates the paper window sticker and so—for new vehicles at least—both the paper and electronic files are generally accurate.

However, the same cannot be said for the used vehicle market. Window stickers are not generally required for used motor vehicles. Even so, many used car vendors do actually create window stickers and physically place them on the car and post them online. The creation of such “aftermarket” window stickers has created many problems. The data needed to construct such a sticker is often inaccurate or at best incomplete. Further, the data is often hand-entered and this introduces additional errors. The result is an inaccurate window sticker.

A remotely located customer may view the window sticker and then travel many miles to physically inspect the car. Upon arriving the customer learns that the car actually has a lower options package than was stated in the sticker. Even worse, some customers actually purchase a car on the basis of the sticker information. A mistake in that information can form the basis of a breach of contract action. At best, the dealer will lose the sale and create an unhappy customer. Car dealers also have a need for the used-car window sticker, such as when a dealer is buying a vehicle at an auction. Used car auctions typically don't list the detailed option-packages on a used car. Thus, the window sticker is quite helpful in this situation.

Many vehicle information data sources receive data on the basis of a vehicle's unique vehicle identification number. All motor vehicles sold in the United States in the past few decades have been assigned a unique vehicle identification number. This is usually referred to as a vehicle's “VIN” or “VIN number.” FIG. 4 shows a common location for a VIN number 14. A plate or tag is provided by the vehicle manufacturer near the bottom of wind shield 16 adjacent to the intersection between hood 12 and A-pillar 10. The plate is protected by the wind shield while also being visible through the wind shield.

Since 1981 VIN numbers in the U.S. have followed a standard 17-character format. FIG. 5 illustrates this format. The numbers shown in the spacing (from 1 to 17) refer to the position in the format and not necessarily to a number that would ever appear in an actual VIN.

World manufacturer identifier 40 provides a unique identifier for the maker of the vehicle. Vehicle attribute section 42 is used by a manufacturer to identify aspects of a particular vehicle—such as engine type and body style. It is not standardized. Check digit 44 is used to validate the rest of the VIN number.

Model year code 46 has been standardized for all U.S. vehicles since 1981. It follows an established sequence. Under the U.S. standard, the letters I(i), O(o), and Q(q) are not used anywhere in a VIN. U, Z, and the digit 0 are not used in the model year codes. Plant code 48 describes where the vehicle emerged from final assembly. Serial number 50 is not standardized and each manufacturer tends to use its own system for identifying its own vehicles.

FIG. 6 shows an actual VIN number with annotations provided for the appropriate sections. World manufacturer identifier 40 in this example is “3FA,” which decodes as Ford Mexico. Attribute section 42 is “DP4EJ.” There is no general standard defining how to decode this sequence. However, in the standard system used by the Ford Motor Company, this sequence decodes to: Fiesta/5 door/hatchback/SE trim.

Model year code 46 is “B.” It is important to note that the model year codes repeat every 30 years. Thus, the code “B” was used for the 1981 model year and for the 2011 model year. Additional information may be needed to resolve this possible ambiguity. The VIN number presented is actually from the 1981 model year.

Plant code 48 is “M.” This decodes as Ford's Cuautitlan-Izcalli assembly facility. Finally, the serial number 50 reads “156937.” This conforms to no general standard but does identify the vehicle within the manufacturer's internal standard.

From the preceding descriptions the reader will understand that a VIN uniquely identifies each vehicle sold in the United States (at least since 1981). In addition, the VIN provides information about the vehicle. However, the VIN by no means provides complete information about a vehicle. It does not, for example, provide enough information to create a complete Monroney sticker as depicted in FIG. 3.

What is needed is a product that takes a unique vehicle identifier and combines it with other available data sources to provide the relevant feature and pricing information for that vehicle. The present invention provides such a solution.

### BRIEF SUMMARY OF THE PRESENT INVENTION

The present invention comprises a system and hardware for creating an accurate motor vehicle “window sticker” using a vehicle identification number and external data sources. The inventive method begins with the acquisition of the vehicle identification number (“VIN”). The system next determines the vehicle make and model year using the VIN and in some instances other data sources. Once the vehicle make and model year is determined, the system accesses detailed information concerning the features and pricing for the particular vehicle from one or more external data sources. A data source adapter is then applied to transform the retrieved data into a usable form.

Next the inventive system cross references the data to verity its accuracy and ensure that the base and option pricing calculated is correct. Finally, the system uses the verified data to create a standardized window sticker in a format familiar to a prospective buyer. The window sticker may be presented in electronic form, physical form, or both.

This summary section is intended to provide a basic understanding of the invention. However, it is not intended to be read as limiting the scope of the invention or as providing an all-encompassing listing of the inventive features. The proper scope of the present invention should be determined by reviewing the claims that follow rather than this brief summary.

### BRIEF DESCRIPTION OF THE SEVERAL VIEWS OF THE DRAWINGS

FIG. 1 is a perspective view, showing a prior art motor vehicle with an attached window sticker.

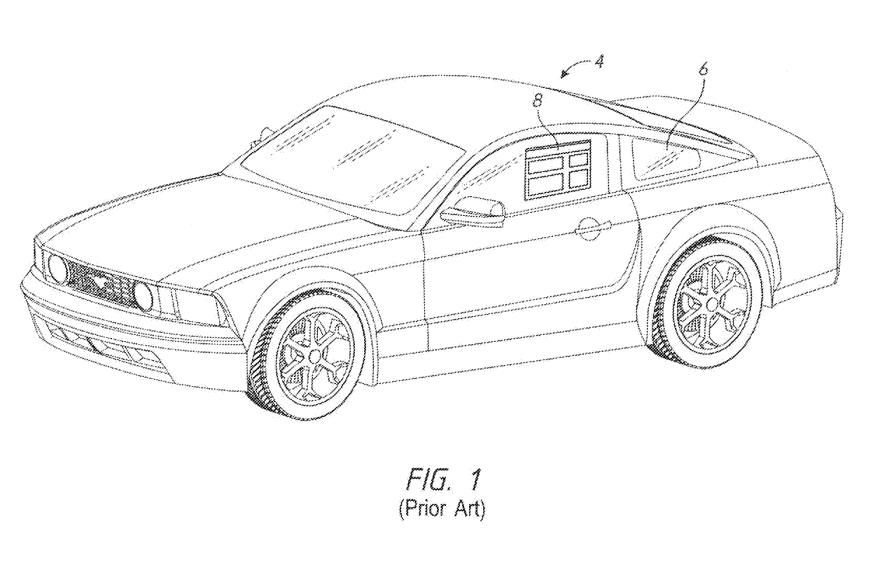

FIG. 2 is a depiction of a format for a prior art Monroney sticker.

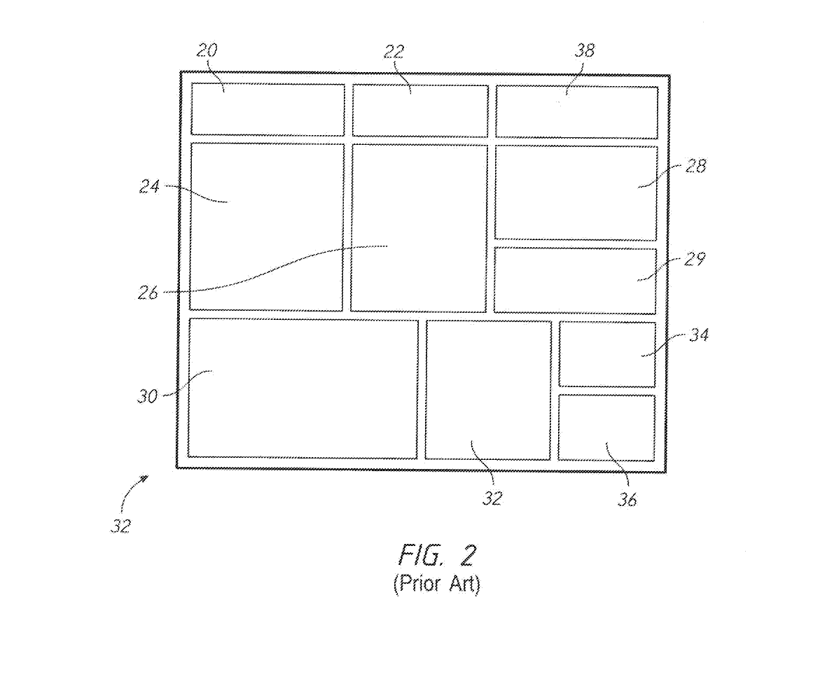

FIG. 3 is a depiction of a specific prior art Monroney sticker.

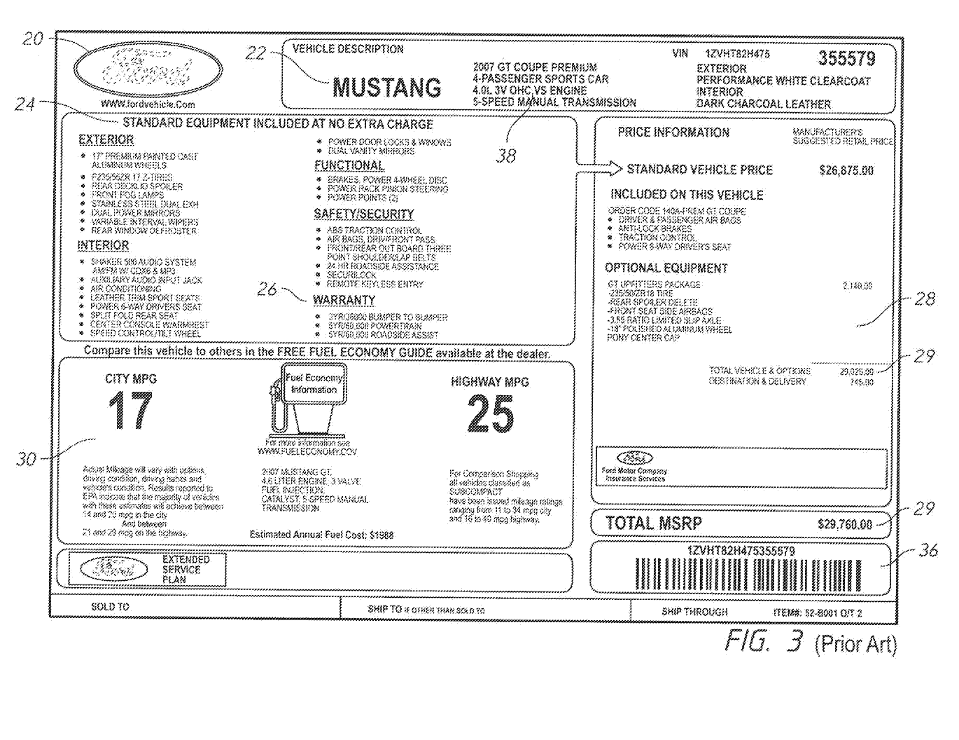

FIG. 4 is a perspective view, showing an exemplary prior art vehicle identification number on a motor vehicle.

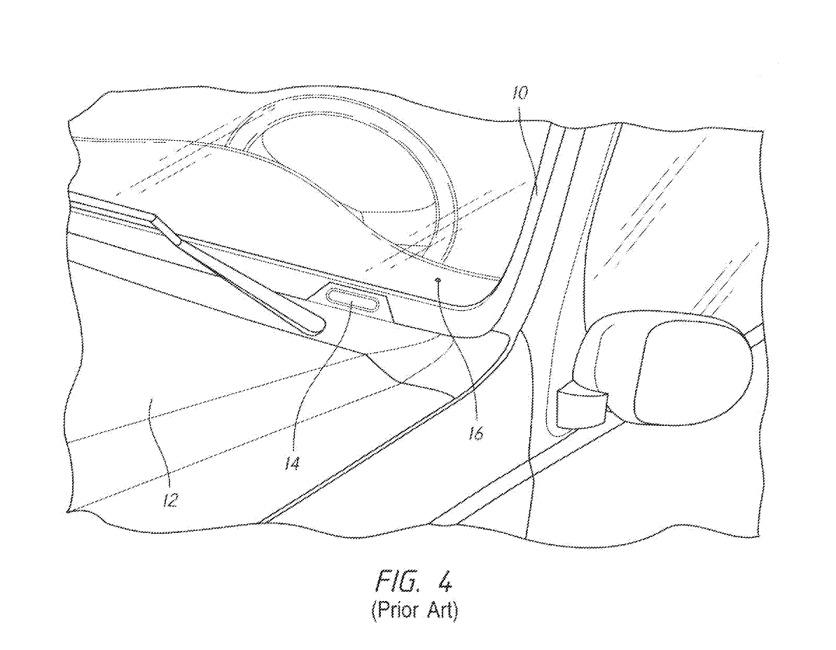

FIG. 5 depicts the character sequence for a vehicle identification number such as used in the United States.

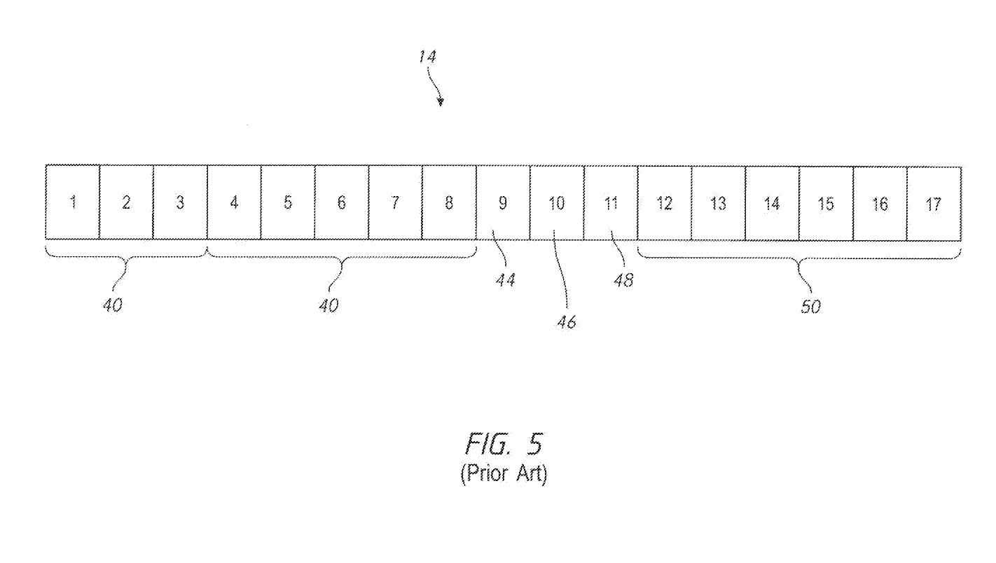

FIG. 6 depicts an exemplary vehicle identification number such as used in the United States.

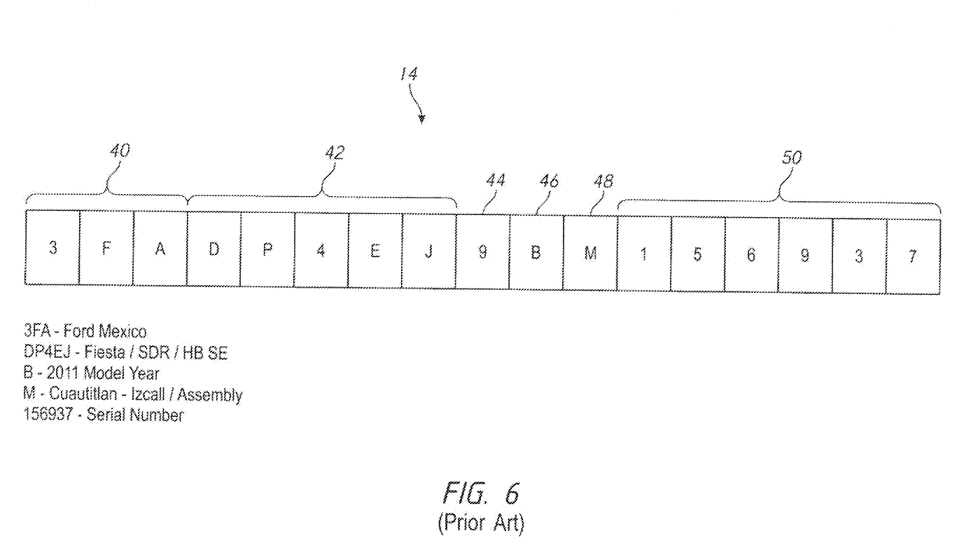

FIG. 7 is a screen shot of an exemplary graphical user interface used to implement the present invention.

FIG. 8 is a perspective view, showing how a portable electronic device may be used to capture a vehicle identification number.

FIG. 9 is a schematic view, showing how the various computer hardware used in the present invention can communicate.

FIG. 10 is a flow diagram, showing some of the steps performed by the software used in the present invention.

FIG. 11 is a flow diagram, showing some of the steps performed by the software used in the present invention.

FIG. 12 is a screen shot of an exemplary graphical user interface used to implement the present invention.

FIG. 13 is a screen shot of an exemplary graphical user interface used to implement the present invention.

FIG. 14 is a screen shot of an exemplary graphical user interface used to implement the present invention.

### REFERENCE NUMERALS IN THE DRAWINGS

4 car

6 window

8 window sticker

10 A-pillar

12 hood

14 vehicle identification number

16 windshield

18 Monroney sticker

20 manufacturer information

22 model information

24 standard equipment information

26 warranty information

28 optional equipment information

29 pricing information

30 fuel economy information

32 crash rating information

34 parts content information

36 VIN information

38 summary information

40 world manufacturer information

42 vehicle attributes

44 check digit

46 model year code

48 plant code

50 serial number

52 portable electronic device

54 display

56 command icon

58 Internet

60 application server

62 data server

64 desktop computer

66 label printer

68 laptop computer

70 wireless router

72 cell service provider

74 step

76 step

78 step

80 step

82 step

84 step

86 step

88 step

90 step

92 step

94 step

96 step

98 step

100 step

102 Monroney label display

104 optional selection

106 summary

108 preview

### DETAILED DESCRIPTION OF THE INVENTION

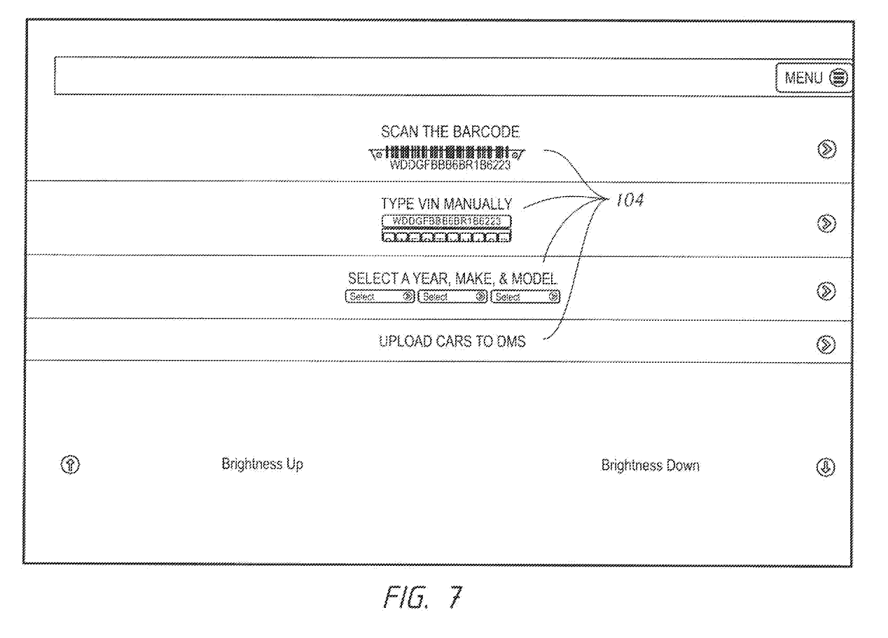

The present inventive method and system uses a vehicle identification number “(“VIN”) as its starting point. The VIN may be entered manually using a computer keyboard. It is more convenient for the user, however, to have an automated “capture” system. FIG. 7 illustrates a “screen shot” from a graphical user interface used to implement the inventive method. The depiction of FIG. 7 may be provided to the user as a display on a portable electronic device such as a smart phone. Optional selections 104 are provided to the user. These allow the user to scan an available VIN, manually enter a VIN, manually select a vehicle, or upload a vehicle (along with identifying information) from an external source. In this example the user elects to scan the VIN.

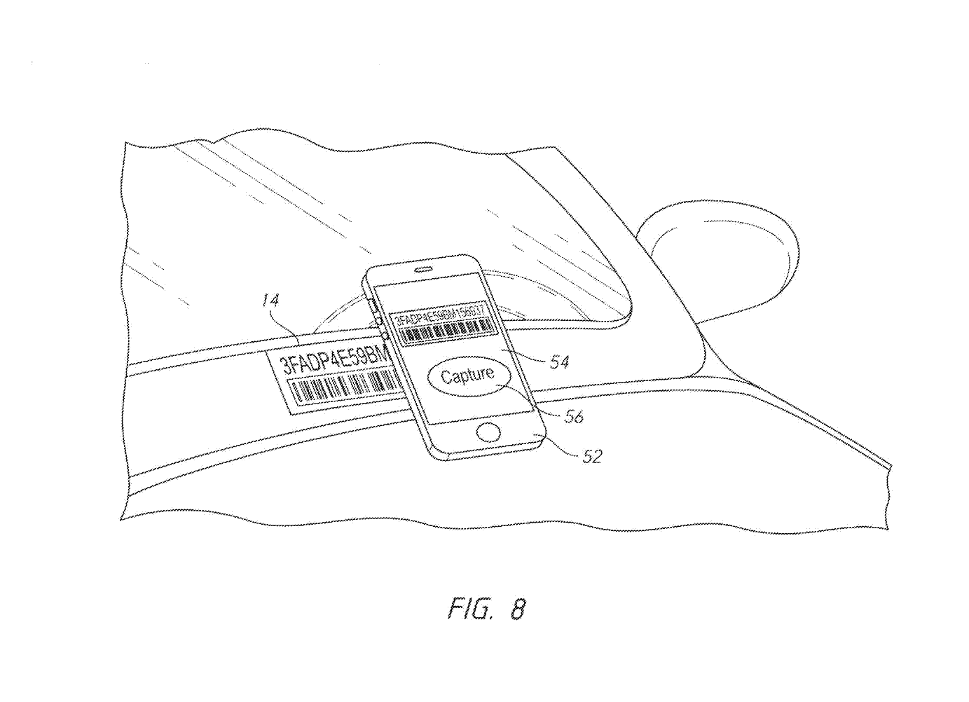

FIG. 8 shows the scanning process. Portable electronic device 52 includes a digital camera (facing away from the viewer in FIG. 7) and display 54. The user aims the device at VIN display 14 on a motor vehicle. An image of the VIN appears on display 54. The user manipulates the electronic device so that VIN 14 is fully visible on display 54. Software running on the device confirms the suitability of the image and then displays command icon 56. The user “presses” command icon 36 by touching the screen. The image of the VIN is then temporarily stored. Application software running on the portable electronic device may then be used to recognize the characters contained within the image (perhaps directly from the characters themselves but often through decoding a bar code or QR code). The VIN may then be stored as a simple character sequence.

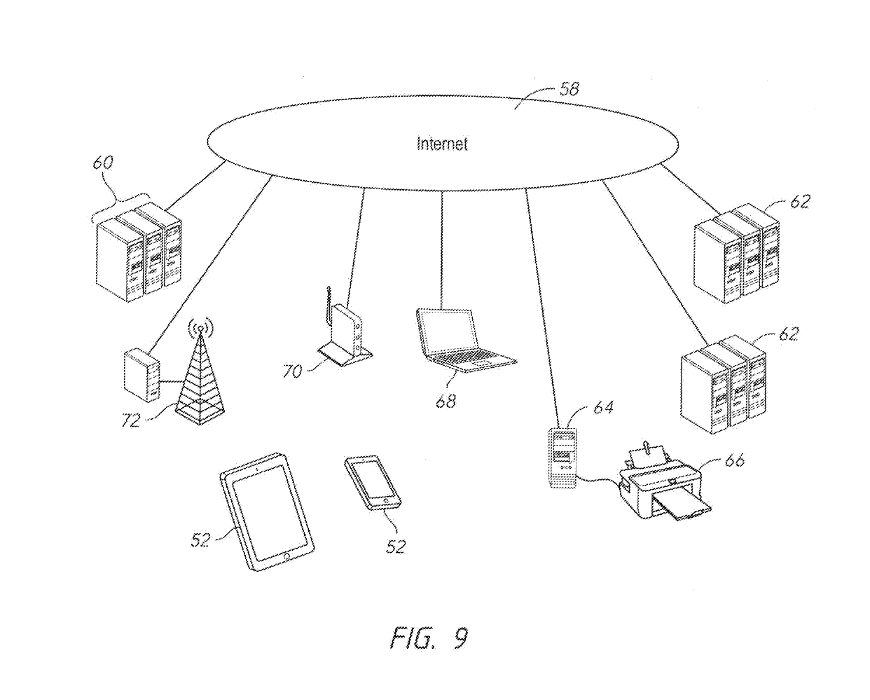

The invention may be implemented using a wide variety of computing devices and communication hardware. FIG. 9 depicts some exemplary hardware. The invention preferably includes one or more application servers 60 running suitable software with associated memory storage. Communications are preferably conducted over the Internet 58, since this will give the broadest possible access to portable devices. Suitable encryption may be used to ensure security.

A vehicle VIN will typically be captured using a portable electronic device 52 (such as a smart phone or tablet). The VIN is then transmitted to application server 60 for processing. This transmission may pass through cell service provider 72 (typically in the case of a smart phone). It may alternatively pass through wireless router 70 or some other channel.

Application server 60 sends external data requests to other databases, such as are housed on remote data servers 62. These requests preferably also pass via Internet 58. An object of the present invention is the creation of an accurate Monroney sticker corresponding to the VIN submitted. Once the data comprising the Monroney sticker has been created, it may be passed back to the original requesting portable electronic device 52. It may also be passed to other devices such as laptop computer 68 or desktop computer 64. These data exchanges are preferably also made through Internet 58. The created Monroney sticker may be displayed on a cell phone or tablet display. It may be incorporated in web-based advertising. It may also be physically printed, such as by sending it to label printer 66.

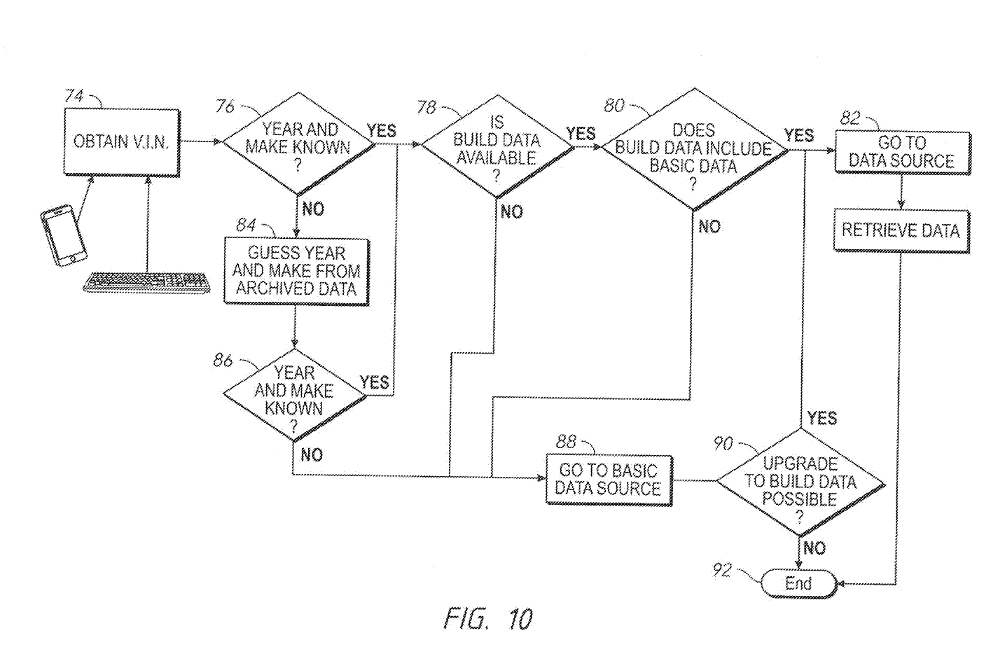

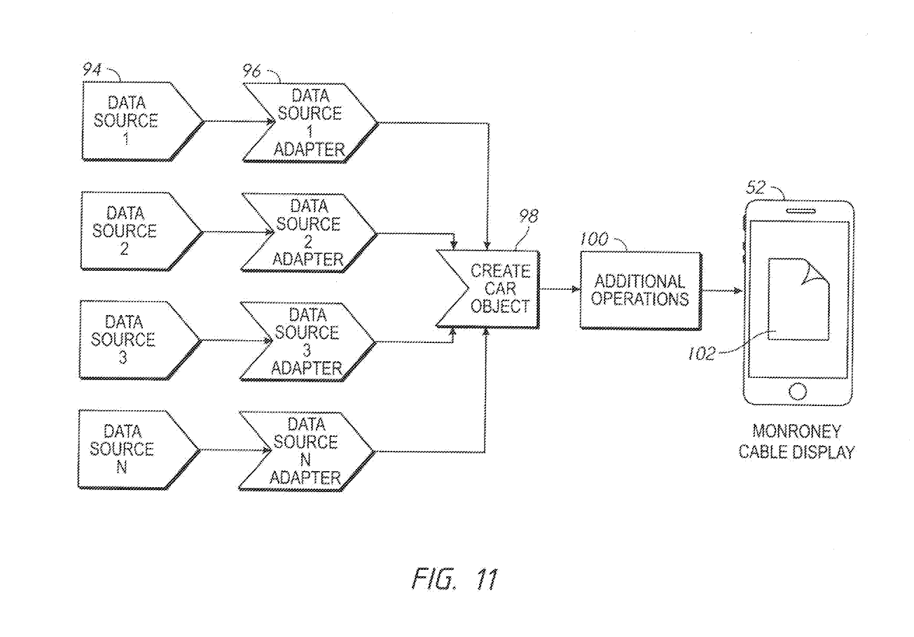

Those skilled in the art will know that the software needed to run the inventive process could be implemented in a virtually endless variety of ways. The following descriptions explain one way of implementing the process. FIGS. 10 and 11 provide flow diagrams for the operations carried out by the software in the inventive system. The inventive method can be broken down into two broad operations. In the first operation, the method takes a VIN and seeks to assemble from external data sources all the information needed to create a Monroney sticker for that vehicle. In the second operation the method takes the external raw data and combines and transforms it to create the Monroney label. FIG. 10 broadly depicts the data gathering process. FIG. 11 broadly depicts the data transforming process.

FIG. 10 starts in the upper left with the obtaining of the vehicle identification number (“VIN”), shown on the diagram as step 74. This description will run through the flow chart as a whole before explaining individual portions in more detail. It is important for the data gathering process to determine the year and make for the vehicle (“year” meaning the year in which the vehicle was made and “make” meaning the identity of the manufacturer). This information is needed in order for the software to determine which external database it should access. For example, the business operating the inventive system may have data sharing agreements with General Motors, Ford, and other manufacturers. Even within one manufacturer, multiple databases may exist for different age ranges of vehicles. A charge is generally assessed for accessing each data source. Thus, one does not want the software to send requests to all possible vehicle data sources. Rather, the software preferably determines the year and make for the vehicle and then sends a request to the appropriate database.

At step 76 the software takes the VIN and asks whether the year and make are known. If the answer is “yes” the software next “asks” whether Build Data is available for that year and make (step 78). If the answer to that question is “yes” the software next asks whether the Build Data includes Basic Data (step 80). If the answer to that question is “yes” then the software selects the appropriate data source and retrieves the Build Data for the particular VIN (step 82). The portion of the steps carried out by the inventive software shown in FIG. 9 then proceeds to end step 92.

If at step 76 then answer is “no” then the software proceeds to “guess” a year and make from archived data (such as by comparing the requested VIN against similar prior VINs for which Build Data has been obtained). If the “guess” is successful (step 86) then the process proceeds on to step 78. If the “guess” is unsuccessful then the process proceeds to step 88. In step 88 the software consults a “Basic Data source.” This is one or more external data sources that are useful in decoding some VINs (but which do not provide complete Build Data).

If the Basic Data source supplies the make and model information, the software then proceeds to step 90, which asks whether it is possible to upgrade the Basic Data to Build Data. If the answer at step 90 is “yes” then the software proceeds to step 82 and the external Build Data is retrieved. If the answer at step 90 is “no” then the software proceeds to end step 92. This result may be deemed only partially successful. It will be possible using the Basic Data to create a Monroney sticker having some useful information, but it will not be complete.

Step 78 asks whether Build Data is available once the vehicle's year of production and make are known. If the answer to this question is “no” then the software moves to step 88 (querying a Basic Data source). The steps then proceed as describe previously.

Step 80 asks whether the Build Data includes Basic Data. This may seem somewhat odd, since Build Data is more comprehensive than Basic Data. However, some databases of Build Data include detailed information (such as interior trim and stereo options) but do not include Basic Data. In such an instance the inventive process returns to step 88 (seeking Basic Data from another source). The process would then proceed to step 90 and would then progress as explained previously.

The operations of FIG. 10 will now be described in more detail. The inventive system may start with the vehicle identification number 3FADP4EJ9BM156937. The software focuses on digits 1-8 and 10-11. The reader will recall from the prior descriptions that these portions of the VIN contain (in this particular example):

3FA—world manufacturer identifier

DP4EJ—vehicle attributes

B—date code

M—manufacturing plant code.

The make is decoded as “Ford Mexico.” The model year code is “B.” The reader will also recall that year codes repeat every 30 years. The code “B” decodes as either 2011 or 1981 (Note that for vehicles older than 2009 this isn't a problem because no 17-digit VIN was standardized for 1979 or before. However, the ambiguity problem will grow over time since more and more VIN's will be from the post-2009 period). It is necessary to know whether the VIN data code represents a 2011 vehicle or a 1981 vehicle in order to most efficiently carry out the inventive process. The data for Ford vehicles of 1981 may not be in the same location as for Ford vehicles for 2011, meaning that it is desirable to resolve this ambiguity prior to sending out data requests and possibly incurring needless data charges.

One solution is simply to present a question back to the user entering the VIN. An application running on a smart phone could present a message to the user: “This VIN is either for a 2011 vehicle or a 1981 vehicle.” The user could then be provided with selection icons to enter an answer (An example of this is shown as an optional selection 104 in the screen shot of FIG. 7). The user might not actually know the model year (recall that the user might be a car dealership employee walking around a lot scanning dozens of vehicles). Nevertheless, most any user will be able to correctly guess between the two possibilities—since they are 30 years apart.

It is preferable, however, to perform the disambiguation automatically. This is where step 84 in FIG. 10 comes in. The reader will recall in the embodiment presented that the software implementing portions of the inventive process runs on an application server or servers. The same software may be given access to a large database of search operations already run. The software then focuses on the portions of the VIN that are useful for disambiguation (digits 1-8 and 10-11). The VIN 3FADP4EJ9BM156937 then becomes 3FADP4EJ*BM****** (the “*” indicating a “wildcard” in the sequence). The software next searches the associated memory to determine if any prior search has been done on a VIN conforming to 3FADP4EJ*BM******. The software determines that such a search has been performed before and that the information ultimately retrieved was for a 2011 Ford Fiesta. In this case the “guess” was successful and the process then proceeds to step 78 in FIG. 10.

Of course, when the system first begins running, this type of matching against prior searches will not be possible. In such a case there may be no choice but to send data requests out to multiple external data sources. For example, a first data source might cover Ford products from 1970-1979, while a second data source might cover Ford products from 1996 to the present. A data request for the VIN 3FADP4EJ9BM156937 could be sent to both data sources. The 1970-1979 data bases would then return a “no such record” error while the later database would return a record “hit.” This information would then be stored by application server 60 both for use in creating a Monroney sticker (the present task) as well as for use in disambiguating future searches.

The software preferably creates an object or class called “Basic Data.” This includes basic information about a vehicle such as its make, model, model year, body style (hatchback, sedan, etc.), and engine type. The software preferably also creates an object or class called “Build Data.” Build Data inherits from Basic Data.

It is important for the reader to appreciate that the Basic Data and Build Data objects are not previously-completed objects that are retrieved from an external source. Rather, the inventive software creates these objects by using data acquired from multiple external sources. As an example, the operator of the inventive system may have an agreement with an automobile manufacturer giving it access (on a paying basis) to the manufacturer's vehicle manufacturing data. The manufacturing data generally refers to all the information the manufacturer used to equip a particular vehicle when it was made. For example, a particular vehicle might have three basic interior trim levels available. However, those three trim levels might be available in 49 different color combinations. In addition, there might be 45 additional interior options available (such as an auto-dimming rear view mirror, an 8-speaker sound system, etc.). At the time the vehicle was built, all the installed options were listed in the manufacturing data. This information is retrieved by the inventive system from the data source that archives it.

The inventive system might then retrieve pricing data from a second data source. This pricing data can be used to append a price to each option found in the manufacturing data. The inventive system might also retrieve basic information from a third data source (such as the vehicle's body type and model name). It might seem odd that this information would not be contained in the manufacturing data but sometimes it is not. The inventive system ultimately seeks to compile all this information into a single Build Data object. The general operations involved in completing the Build Data object and ultimately creating a Monroney sticker are shown in FIG. 11.

Once the appropriate data are retrieved from the separate sources, the data must be transformed into a usable format and then used to create a desired end product. Data sources 1 through n may assume a wide variety of forms and formats—even where they contain essentially the same information. For example, Data source 1 might store a vehicle's base suggested retail price as:

:@msrp=>“24,900.00”

Data source 2 might store the exact same information as:

Base_msrp: 24900

In the embodiment depicted, a data source adapter 96 is provided for each data source the system accesses. The data source adapter is programmed to retrieve and organize the desired information in the data and convert it into a consistent format that is used for subsequent internal operations. For example, the inventive system might define an internal variable called “BASE_MSRP” After the information is retrieved it is converted into a value for the variable “BASE_MSRP” regardless of the format of the original data. Data source adapters may also call other adapters and perform internal calculations in order to create a consistent format.

Step 98 takes all this available information and uses it to create a class or object named Car Object. Car Object contains all the information obtained for a particular VIN, transformed into a format that is similar to the final window sticker format. Additional operations (100) are then performed to create the final data that is ready to be used for the Monroney label.

The additional operations may assume many forms. As one example, it is often necessary to apply algorithms to avoid duplications in the pricing data. For instance, a particular vehicle may have come equipped with the “LS comfort package” (This is an “option group package” meaning a clustering of multiple options into a group with one total price). The LS comfort package shows a manufacturer's suggested retail price of $4,200. In the manufacturing data, there are line items for “steering wheel stereo controls” and “heated seats,” both of which carry an additional price as an added option. The MSRP for the steering wheel controls is $800 while the MSRP for the heated seats is $550. In step 100, the software determines that both the steering wheel controls and the heated seats are included in the “LS comfort package.” The software then ensures that the individual MSRP's for the options are not included in the calculation of the total vehicle MSRP, since that would produce a double counting.

Once the additional calculations are performed, the software formats the data for presentation as a familiar Monroney label 102. In the example of FIG. 11, the Monroney label is presented as an image on a digital device. Differing levels of detail can be provided for the presentation, possibly depending upon the size of the display screen available.

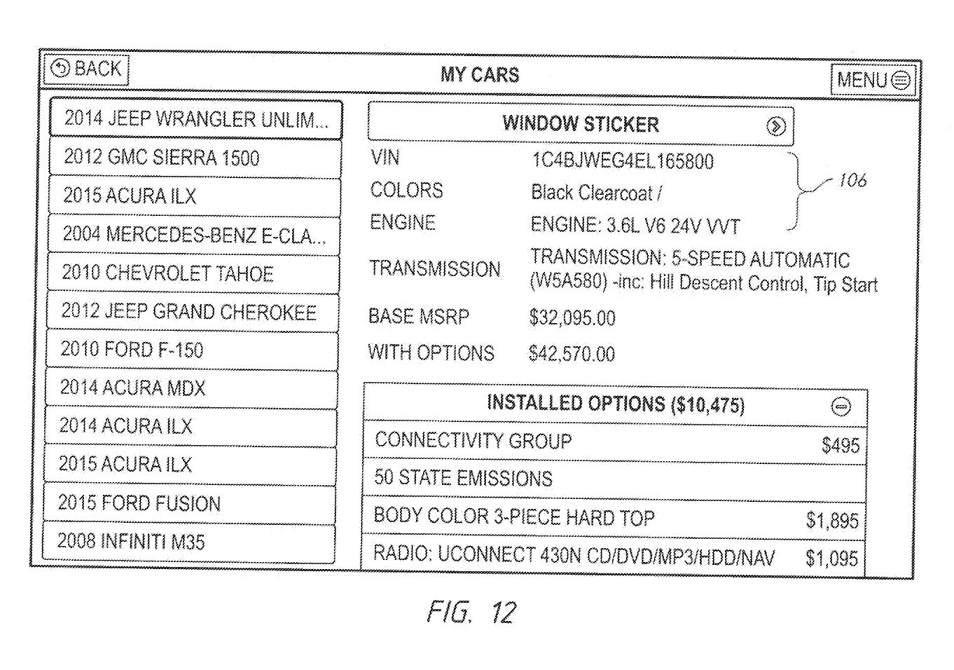

FIG. 12 shows a summary depiction of the Monroney label—such as might be suitable for presentation on a small screen on a smart phone. Summary 106 provides the most basic information that is customarily used to compare one vehicle to another.

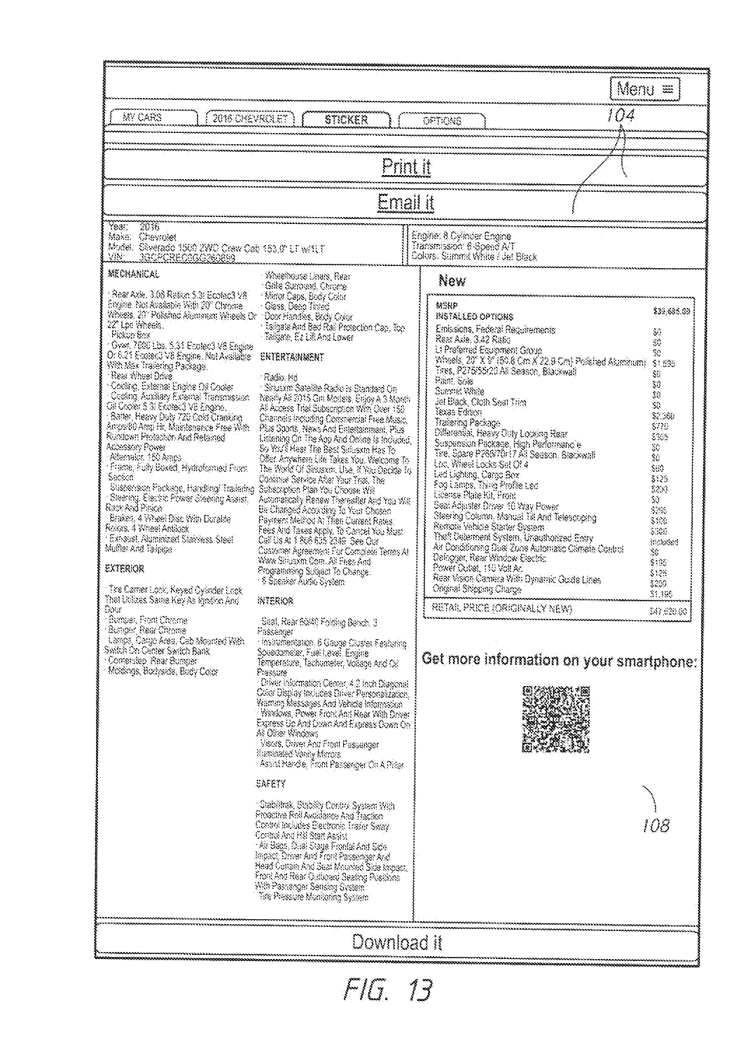

FIG. 13 presents a more detailed depletion, conforming to the level of detail typically found on a physical window sticker. Preview 108 is intended to be a “what-you-see-is-what-you-get” depiction. Optional selections 104 allow the user to print the completed label or email it to a selected address. The label can be graphically presented as a display on a digital device or as a physical window sticker.

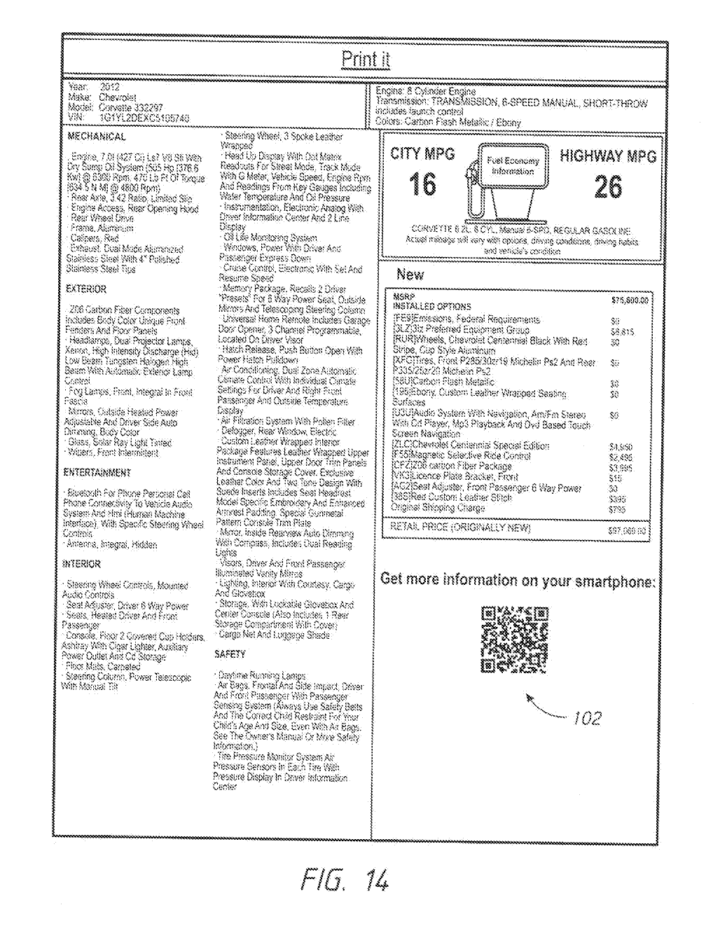

FIG. 14 shows a larger depiction of Monroney label display 102. The exemplary interface then allows the user to select a print icon to produce a physical print conforming to the depiction.

Returning now to FIGS. 10 and 11, some of the terminology used will be explained in more detail. The inventive process is carried out on a first computer system having an associated memory storing a database. The associated database does contain some vehicle records. These may be used in step 86 to determine a year and make for the current VIN by comparing it against previously-searched VIN's and the records returned for those previously-searched VIN's. However, most of the data retrieved by the inventive software will be retrieved from external data sources. In other words, the inventive software will send a VIN-data request (typically over the Internet) to a data source hosted by a remote server and receive a reply from that remote server.

In FIG. 11, the retrieved data is used to create a car object in the software (step 98). This could more generally be described as the creation of a “software vehicle object” (since the inventive system can be used for vehicles other than cars). The software vehicle object preferably contains all the information needed to create a Monroney sticker or label. This would include:

1. Vehicle make;

2. Vehicle model;

3. Vehicle model year;

4. Color;

5. Engine and transmission type;

6. VIN;

7. All options;

8. Base MSRP;

9. MSRP for all options; and

10. Information needed to avoid double counting of an individual option that is also part of an option group package.

The software and hardware implementing the inventive process may include many other features and combinations of features in addition to those disclosed for the preferred embodiments. These include:

1. The entire process could be configured to run as a “stand-alone” application on a single computing device, as long as the computing device had access to the external resources containing the vehicle information;

2. The data exchanges could be done using dedicated data lines rather than via the Internet;

3. The graphical user interface could assume a different form;

4. A command-based interlace could be used instead of a graphical user interface;

5. The VIN capture can be made by reading a bar or QR code in a vehicle's documentation rather than the VIN plate itself; and

6. The inventive process may be made available to a consumer as a downloadable “app” (application) running on a portable device such as a smart phone or tablet.

Although the preceding description contains significant detail, it should not be construed as limiting the scope of the invention but rather as providing illustrations of the preferred embodiments of the invention. One skilled in the art may easily devise variations on the embodiments described. Thus, the scope of the invention should be fixed by the claims rather than the examples given.

Having described our invention, we claim:

1. A method for taking a motor vehicle's vehicle identification number and using it to access external data sources in order to create a formatted presentation of information specific to said motor vehicle, comprising:
a. providing a first computing device running software, said first computing device having an associated local database;
b. providing said vehicle identification number to said software;
c. said software determining a year and a make for said vehicle;
d. said software using said determined year and make for said vehicle to select an appropriate one of said external data sources to access in order to obtain said information for said vehicle;
e. said software accessing said external data source and retrieving said information for said vehicle;
f. providing in said software a plurality of data source adapters, each of which is configured to convert data from a specific external data source to a consistent format;
g. selecting one of said data source adapters configured to convert data from said selected external data source;
h. applying said selected data source adapter to said information obtained from said selected external data source to create a software vehicle object;
i. said software using said software vehicle object to determine a price for all options applicable to said vehicle and a total price for said vehicle;
j. formatting said information for said vehicle, said options price for said vehicle, and said total price for said vehicle to create a window sticker; and
k. graphically presenting said window sticker.

2. A method for creating a formatted presentation of information specific to a motor vehicle as recited in claim 1, wherein said step of calculating a price for all options applicable to said vehicle and a total price for said vehicle comprises:
a. said software determining a manufacturer's, suggested retail price for each option on said vehicle;
b. said software determining a manufacturer's suggested retail price for all option group packages on said vehicles; and
c. said software eliminating any redundancies between said options and said option group packages.

3. A method for creating a formatted presentation of information specific to a motor vehicle as recited in claim 1, comprising:
a. said software obtaining said information from multiple external data sources; and
b. said software using said information from said multiple external data sources to create said software vehicle object.

4. A method for creating a formatted presentation of information specific to a motor vehicle as recited in claim 1, wherein said step of graphically presenting said window sticker comprises displaying said window sticker on a portable electronic device.

5. A method for creating a formatted presentation of information specific to a motor vehicle as recited in claim 1, wherein said step of graphically presenting said window sticker comprises physically printing said window sticker.

6. A method for creating a formatted presentation of information specific to a motor vehicle as recited in claim 1, wherein said step of providing said vehicle identification number to said software comprises:
a. providing a portable electronic device with an integral digital camera;
b. providing application software running on said portable electronic device;
c. aiming said integral digital camera at a vehicle identification number display on said vehicle; and
d. using said application software to process data from said integral digital camera and convert said data to a character sequence that is said vehicle identification number.

7. A method for creating a formatted presentation of information specific to a motor vehicle as recited in claim 6, comprising transmitting said character sequence to said first computing device.

8. A method for creating a formatted presentation of information specific to a motor vehicle as recited in claim 1, wherein said step of determining a year and make for said vehicle comprises:
a. comparing said vehicle identification number against other vehicle identification numbers stored in said local database; and
b. upon discovering a match of world manufacturer identifier information, vehicle attribute information, vehicle model year information, and plant code information between said vehicle identification number and said other vehicle identification numbers, using said other vehicle identification numbers to retrieve a year and make for said vehicle identification number from said associated local database.

9. A method for creating a formatted presentation of information specific to a motor vehicle as recited in claim 1, wherein said step of determining a year and make for said vehicle comprises using world manufacturer identifier information and model year information from said vehicle identification number.

10. A method for creating a formatted presentation of information specific to a motor vehicle as recited in claim 1, further comprising emailing said window sticker to a portable electronic device.

11. A method for taking a motor vehicle's vehicle identification number and using it to access external data sources in order to create a Monroney sticker specific to said motor vehicle, comprising:
a. providing a first computing device running software, said first computing device having an associated memory or database;
b. acquiring said vehicle identification number and loading said vehicle identification number into said software;
c. said software automatically determining a year and a make for said vehicle;
d. said software using said determined year and make for said vehicle to select an appropriate one of said external data sources to access in order to obtain said information for said vehicle;
e. said software using the Internet to access said external data source and retrieve build data for said vehicle;
f. providing in said software a plurality of data source adapters, each of which is configured to convert said build data from a specific external data source to a consistent format;
g. selecting one of said data source adapters configured to convert said build data from said selected external data source;
h. applying said selected data source adapter to said build data obtained from said selected external data source to create a software vehicle object;
i. said software using said software vehicle object to determine a price for all options applicable to said vehicle and a total price for said vehicle;
j. formatting said information for said vehicle, said options price for said vehicle, and said total price for said vehicle to create said Monroney sticker; and
k. graphically presenting said Monroney sticker.

12. A method for creating a formatted presentation of information specific to a motor vehicle as recited in claim 11, wherein said step of calculating a price for all options applicable to said vehicle and a total price for said vehicle comprises:
a. said software determining a manufacturer's suggested retail price for each option on said vehicle;
b. said software determining a manufacturer's suggested retail price for all option group packages on said vehicles; and
c. said software eliminating any redundancies between said options and said option group packages.

13. A method for creating a formatted presentation of information specific to a motor vehicle as recited in claim 11, comprising:
a. said software obtaining said information from multiple external data sources; and
b. said software using said information from said multiple external data sources to create said software vehicle object.

14. A method for creating a formatted presentation of information specific to a motor vehicle as recited in claim 11, wherein said step of graphically presenting said window sticker comprises displaying said window sticker on a portable electronic device.

15. A method for creating a formatted presentation of information specific to a motor vehicle as recited in claim 11, wherein said step of graphically presenting said window sticker comprises physically printing said window sticker.

16. A method for creating a formatted presentation of information specific to a motor vehicle as recited in claim 11, wherein said step of providing said vehicle identification number to said software comprises:
a. providing a portable electronic device with an integral digital camera;
b. providing application software running on said portable electronic device;
c. aiming said integral digital camera at a vehicle identification number display on said vehicle; and
d. using said application software to process data from said integral digital camera and convert said data to a character sequence that is said vehicle identification number.

17. A method for creating a formatted presentation of information specific to a motor vehicle as recited in claim 16, comprising transmitting said character sequence to said first computing device.

18. A method for creating a formatted presentation of information specific to a motor vehicle as recited in claim 11, wherein said step of determining a year and make for said vehicle comprises:
a. comparing said vehicle identification number against other vehicle identification numbers stored in said associated memory or database; and
b. upon discovering a match of world manufacturer identifier information, vehicle attribute information, vehicle model year information, and plant code information between said vehicle identification number and said other vehicle identification numbers, using said other vehicle identification numbers to retrieve a year and make for said vehicle identification number from said associated memory.

19. A method for creating a formatted presentation of information specific to a motor vehicle as recited in claim 11, wherein said step of determining a year and make for said vehicle comprises using world manufacturer identifier information and model year information from said vehicle identification number.

20. A method for creating a formatted presentation of information specific to a motor vehicle as recited in claim 11, further comprising emailing said window sticker to a portable electronic device.
